(19) United States
(12) Patent Application Publication
(10) Pub. No.: US 2004/0122538 A1
(43) Pub. Date: Jun. 24, 2004

(54) Golf scoring average determining method and system

(76) Inventor: Edward Francis Gowan, Scottsdale, AZ (US)

Correspondence Address: WEISS & MOY PC, 4204 NORTH BROWN AVENUE, SCOTTSDALE, AZ, 85251, US

(21) Appl. No.: 10/328,377

(22) Filed: Dec. 24, 2002

(51) Int. Cl. G06F 155/00

(52) U.S. Cl. 700/92

(57) ABSTRACT

A golf scoring average determining method and system provides a means for golfers to evaluate their current scoring ability with respect to a particular golf course as well as evaluating their average performance against other players and their own progress. Statistical data is collected from player scores and other factors and course adjustments are determined from a statistical analysis of multiple games played by multiple players at a given course. Player scores and other factors are normalized by statistically-derived average course factors such as course yardage and average approach length. Putting performance is also evaluated on a statistical basis to yield a putting average and individual putting grades. The method may be embodied in a server program providing access via an Internet website or may be embodied in dedicated terminals located at golf courses or golf shops.

### BACKGROUND OF THE INVENTION

1. Field of the Invention

The present invention relates generally to golfer evaluation systems, and more particularly to a method and system for predicting golf scores based on course and player historical information.

2. Background of the Invention

Golf players and golfing associations have a need to evaluate and track the performance of golfers. Improvement in golf performance is of great concern to many golfers and the relative difficulty of golf courses over a variety of conditions is generally of interest to both golfers and course management. Various methods and systems have been proposed and implemented to evaluate both players and courses.

One such method and system is the “Handicap” system used by the United States Golf Association (USGA). However, a handicap is only available to members of clubs or associations that follow the requirements of the USGA Handicap System and thus many golfers are not eligible for a handicap, in particular those golfers who play public courses or are not members of USGA golf clubs. The traditional handicap system evaluated course difficulty strictly based on yardage, with modifications to yardage made based on recommendations of a committee with respect to perceived course difficulty.

Modifications of the handicap system have been implemented that provide evaluation of course difficulty based on a complicated assessment of hole design characteristics, that determined the relative affect on players of different abilities, but none of the above-mentioned systems takes into account the various strengths and weaknesses of individual golfers. Also, “par” is, in the perception of most players, a measure of the difficulty of a course and in their individual performance per hole or per course. The existing USGA methodologies do not include considerations of par.

Therefore, it would be desirable to provide a method and system enabling all golfers to evaluate their current playing skill. It would further be desirable to provide a method and system that can predict a likely next golf score for a player based upon player and course historical data.

### SUMMARY OF THE INVENTION

The above objectives of evaluating and predicting golfer performance in a method and system that rates golfers and courses based on historical scoring data for individual golfers, as well as golf courses. The method adjusts a golf score by a yardage factor and a par factor to yield an adjusted score and to maintain a scoring average for the player. The par factor is statistically adjusted for a particular course in conformity with collected game statistics provide by multiple players for the particular course. A putting score is also adjusted by an average putting factor and a course factor to yield a putting grade for the round and to maintain a putting average for the player.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a flowchart depicting a method in accordance with an embodiment of the present invention.

FIG. 2 is a pictorial diagram depicting a system in accordance with an embodiment of the present invention.

FIG. 3 is a block diagram depicting a system in accordance with an embodiment of the present invention.

### DETAILED DESCRIPTION OF THE EMBODIMENTS

The present invention provides a method and various system embodiments for providing a means for a golfer to evaluate their golfing performance and predict likely next scores at a golf course. The method determines a Scoring Average (SA) that represents an analysis of historical data regarding a particular golfer's past performance and historical data regarding the performance of many golfers at particular courses. The player components of the scoring average include putting strokes, total scores (referred to as “score”), tees played, eagles, birdies, bogeys, double bogeys, other scores, greens in regulation (the number of holes where the green is hit within two strokes under par—leaving two putts for par), and courses played. The course components of the scoring average include par, yardage, scoring records against individual hole pars and green sizes.

The SA method and system of the present invention provide a mechanism to predict a golfer's likely next score at a particular course, and not the golfer's “potential” to make a given score as the present USGA handicap system does. Thus, the present invention provides a valuable tool for providing golfers immediate statistical feedback on their performance and likely next score. The system provides this feedback and prediction capability primarily through individual Internet access to a website, but alternatively or in combination, dedicated terminals located at golf courses or golf shops may be employed for data collection and score prediction/performance average presentations. Access at a golf course or other location by golf course and event managers may include access to data for groups of players, providing a mechanism for evaluating golfers for entry into an event, maintenance of golf courses and management of golf club player groups.

Statistical methods are used to correct for manipulation of scores by using a system of checks and balances that identify legitimate deviations from normal scoring ranges for a player, while rejecting those scores that appear to be incorrectly entered or falsified.

Various terms are used in the present application to refer to the various components of the SA calculation. Below are some of the common terms and their definitions:

Score—The total strokes taken in playing a given course.

Course—A golf course played, including yardage, tee designation and par.

Adjusted Score (AS)—A score adjusted for relative difficulty of the course: yardage, par and historical data related to difficulty of individual holes in a course.

Scoring Average (SA)—A scoring average calculated from the current AS and historical AS data for a particular player.

Predicted Score Table—A table of allowable hole scores versus par for an individual AS. AS scores that fall outside the range are adjusted to more accurately represent a player's expected score for that range of score. Data on individual holes is used to make the adjustment.

Scoring Record—A historical accumulation of previous scores returned for a particular historical time interval (e.g., 12 months) or of a particular number of scores (e.g., the last 50 games).

Putting Grade—A letter grade (from A+ to E−) representing an evaluation of the number of putts adjusted for course conditions and green sizes and normalized to an average player putting rating.

Putting Average—A historical analysis of a player's previous Putting Grades.

Player Entry Fields—Data entry fields completed by a golfer related to specific scores. The fields may permit hole-by-hole scoring data, or alternatively a total score along with the number of eagles, birdies, pars, bogeys, double bogeys and other scores. The fields also provide entry for the number of greens hit in regulation, number of putts, course name, yardage played, date, and may include weather data and course condition data.

Effective Par—A value for par determined by players' accumulated scoring ability relative to distance as determined from data collected from individual hole scoring data from all SA players.

Type—An optional division of scores into categories (event, casual, tournament, new course played) to further quantify the ability of players to score effectively in different environments and under different conditions.

By providing entry of detailed golfer performance data and course design and condition data, a sophisticated scoring prediction method and rating system is implemented using the techniques described below. Most of the calculations are performed differently for men and women as weighted against different estimated averages for each.

Calculations

1. Adjusted Score (AS)

Men's AS=Current Score+(6340−course yardage)/165+(72−course par)

Women's AS=Current Score+(5460−course yardage)/140+(72−course par)

The above calculations weight a score for course difficulty as against course par (average 72) and course length as against a nominal course length. For example, a male scoring 84 on a course of 6626 yards with par 71, would yield an adjusted score of 84+(6340−6626)/165+(72−71)=84−1.75+1=83.25=AS.

2. Scoring Average (SA)

For players with more than a 10 score history:

SA=1/3AS Score History+2/3 Recent History+Range Deviation

For players with 10 or less score history:

SA=Recent History+Range Deviation

An alternative calculation weighting the most recent adjusted score higher in the scoring average is given by the following expressions. The following calculation is preferred for players with a large AS history (for example those players with a >50 AS history) and for instances where the range deviations are large for long periods of time, but it also represents generally an alternative scheme for computing an SA.

SA=(AS Score History+Recent History+AS)/3+Range Deviation

AS Score History=Average (excluding the current AS) of last 50 AS or all accumulated AS in last 12 months, whichever is less, excepting the top 10% of accumulated AS.

Recent History=Average of last 10 AS including the current AS.

Range deviation=Factor added to compensate for out-of-range AS. AS is compared to allowable range (shown in Table 1 below) and SA is reduced by 0.5 for each stroke AS is below bottom of range or increased by 1 if AS is above top of range (no matter how many strokes). The ranges in Table 1 have been determined from a statistical analysis of several hundred thousand golf scores and further may be categorized as “Expert” and “Average” player ranges. An expert is a player whose average score is 70-79 on a course of average length, an average player is a golfer who plays at least monthly and has an average score of 80-94 (Men) or 80-110 (Women) on a course of average length. Average driving distances have been determined as: Expert Men 260y, Expert Women 210y, Average Men 210y and Average Women 150y. Average Approach distances have been determined as: Expert Men 165y, Expert Women 140y, Average Men 135y and Average Women 90y (at par 3 holes of average approach lengths, expert players will average par, while average players will average bogey). Putting averages are: Men 32 putts/round, Women 36 putts/round. Average course lengths from player supplied data are Men 6340y, Women 5460y.

The above given empirically or statistically derived factors provide input to the calculations in the SA system (e.g., the average yardage is used in the SA calculations to adjust the course length and the expert approach distances used to normalize the adjusted course length). The factors are updated by statistical analysis of scoring information received by the system and/or other research data that reflects changes in golfing technology and golf course design rules as well as changes in player trends that occur over time. For example, proposed golf ball standards changes may increase golfing difficulty, decreasing average driving yardage and lowering average scores. The changes can be accounted for by research yielding updated driving and scoring information, by statistical analysis of scoring data or by a combination of both techniques.

The ranges in Table 1 are selected by determining the patterns of birdies, pars, bogeys and double-bogeys that best fit the historical performance of the player. Player totals differing from the “variability” table indicate scoring trends inconsistent with predicted scores, forcing additional adjustments to the AS, that are indicated from accumulated data in the player's personal history. As sufficient data is collected by the system, each player's score history and variability references generate an anticipated “Variability Index” for individual player's future scores that is a measure of player consistency and further indicates whether or not a variation should be allowed, discarded or adjusted using a variation formula.

TABLE 1

| Predicted scores and scoring | | | | | | | | | |
|---|---|---|---|---|---|---|---|---|---|
| | +/− | | | | | Variability Allowed | | | |
| | Par | | | | | −1 | 0 | +1 | +2 |
| | 72 | | | | D. | | | | D. |
| Range | Score | Birdie | Par | Bogey | Bogey | Birdie | Par | Bogey | Bogey |
| 65-73/8 | 69 | 4 | 13 | 1 | 0 | 4 | 13 | 1 | 0 |
| 66-74/8 | 70 | 4 | 12 | 2 | 0 | 4 | 12 | 2 | 0 |
| 67-75/8 | 71 | 3 | 13 | 2 | 0 | 3 | 13 | 2 | 0 |
| 68-76/8 | 72 | 3 | 12 | 3 | 0 | 3 | 12 | 3 | 0 |
| 69-77/8 | 73 | 3 | 11 | 4 | 0 | 3 | 12 | 4 | 0 |
| 70-79/9 | 74 | 2 | 12 | 4 | 0 | 2 | 12 | 4 | 0 |
| 71-80/9 | 75 | 2 | 12 | 3 | 1 | 2 | 11 | 4 | 0 |
| 72-81/9 | 76 | 2 | 11 | 4 | 1 | 2 | 11 | 4 | 0 |
| 72-82/ | 77 | 1 | 12 | 4 | 1 | 2 | 11 | 4 | 0 |
| 10 | | | | | | | | | |
| 73-83/ | 78 | 1 | 11 | 5 | 1 | 2 | 10 | 5 | 0 |
| 10 | | | | | | | | | |
| 74-84/ | 79 | 1 | 10 | 6 | 1 | 1 | 10 | 6 | 0 |
| 10 | | | | | | | | | |
| 75-86/ | 80 | 0 | 11 | 6 | 1 | 0 | 10 | 6 | 1 |
| 11 | | | | | | | | | |
| 76-87/ | 81 | 0 | 10 | 7 | 1 | 0 | 9 | 7 | 1 |
| 11 | | | | | | | | | |
| 77-88/ | 82 | 0 | 10 | 6 | 2 | 0 | 9 | 7 | 1 |
| 11 | | | | | | | | | |
| 78-90/ | 83 | 0 | 9 | 7 | 2 | 0 | 9 | 8 | 1 |
| 12 | | | | | | | | | |
| 79-91/ | 84 | 0 | 8 | 8 | 2 | 0 | 8 | 8 | 2 |
| 12 | | | | | | | | | |
| 80-92/ | 85 | 0 | 7 | 9 | 2 | 0 | 8 | 9 | 2 |
| 12 | | | | | | | | | |
| 81-94/ | 86 | 0 | 6 | 10 | 2 | 0 | 8 | 9 | 2 |
| 13 | | | | | | | | | |
| 82-95/ | 87 | 0 | 5 | 11 | 2 | 0 | 7 | 8 | 3 |
| 13 | | | | | | | | | |
| 83-96/ | 88 | 0 | 5 | 10 | 3 | 0 | 7 | 8 | 3 |
| 13 | | | | | | | | | |
| 84-98/ | 89 | 0 | 4 | 11 | 3 | 0 | 7 | 8 | 3 |
| 14 | | | | | | | | | |
| 84-98/ | 90 | 0 | 3 | 12 | 3 | 0 | 6 | 7 | 4 |
| 14 | | | | | | | | | |
| 85-99/ | 91 | 0 | 3 | 11 | 4 | 0 | 6 | 7 | 4 |
| 14 | | | | | | | | | |
| 85-100/ | 92 | 0 | 2 | 12 | 4 | 0 | 6 | 7 | 4 |
| 15 | | | | | | | | | |
| 86-101/ | 93 | 0 | 2 | 11 | 5 | 0 | 6 | 6 | 5 |
| 15 | | | | | | | | | |
| 87-102/ | 94 | 0 | 1 | 12 | 5 | 0 | 6 | 6 | 5 |
| 15 | | | | | | | | | |
| 88-104/ | 95 | 0 | 1 | 11 | 6 | 0 | 5 | 6 | 5 |
| 16 | | | | | | | | | |
| 89-105/ | 96 | 0 | 0 | 12 | 6 | 0 | 5 | 6 | 5 |
| 16 | | | | | | | | | |
| 90-106/ | 97 | 0 | 0 | 11 | 7 | 0 | 5 | 5 | 6 |
| 16 | | | | | | | | | |
| 91-107/ | 98 | 0 | 0 | 12 | 7 | 0 | 5 | 5 | 6 |
| 16 | | | | | | | | | |
| 92-108/ | 99 | 0 | 0 | 11 | 8 | 0 | 4 | 5 | 6 |
| 16 | | | | | | | | | |
| 93-109/ | 100 | 0 | 0 | 12 | 8 | 0 | 4 | 4 | 7 |
| 16 | | | | | | | | | |
| 94-110/ | 101 | 0 | 0 | 13 | 8 | 0 | 4 | 4 | 7 |
| 16 | | | | | | | | | |
| 95-111/ | 102 | 0 | 0 | 12 | 9 | 0 | 4 | 4 | 7 |
| 16 | | | | | | | | | |
| 96-112/ | 103 | 0 | 0 | 13 | 9 | 0 | 4 | 4 | 7 |
| 16 | | | | | | | | | |
| 97-113/ | 104 | 0 | 0 | 12 | 10 | 0 | 3 | 4 | 8 |
| 16 | | | | | | | | | |
| 98-114/ | 105 | 0 | 0 | 12 | 10 | 0 | 3 | 4 | 8 |
| 16 | | | | | | | | | |
| 99-115/ | 106 | 0 | 0 | 11 | 10 | 0 | 3 | 4 | 8 |
| 16 | | | | | | | | | |
| 100-116/ | 107 | 0 | 0 | 11 | 11 | 0 | 3 | 4 | 8 |
| 16 | | | | | | | | | |
| 101-117/ | 108 | 0 | 0 | 11 | 11 | 0 | 3 | 4 | 8 |
| 16 | | | | | | | | | |
| 102-118/ | 109 | 0 | 0 | 10 | 11 | 0 | 3 | 4 | 7 |
| 16 | | | | | | | | | |
| 104-119/ | 110 | 0 | 0 | 10 | 12 | 0 | 2 | 4 | 7 |
| 15 | | | | | | | | | |
| 105-120/ | 111 | 0 | 0 | 10 | 12 | 0 | 2 | 4 | 7 |
| 15 | | | | | | | | | |
| 106-121/ | 112 | 0 | 0 | 10 | 12 | 0 | 2 | 4 | 7 |
| 15 | | | | | | | | | |
| 107-121/ | 113 | 0 | 0 | 9 | 13 | 0 | 2 | 4 | 7 |
| 14 | | | | | | | | | |
| 108-122/ | 114 | 0 | 0 | 9 | 13 | 0 | 2 | 4 | 6 |
| 14 | | | | | | | | | |
| 109-123/ | 115 | 0 | 0 | 9 | 13 | 0 | 2 | 4 | 6 |
| 14 | | | | | | | | | |
| 110-123/ | 116 | 0 | 0 | 8 | 13 | 0 | 2 | 4 | 6 |
| 13 | | | | | | | | | |
| 111-124/ | 117 | 0 | 0 | 8 | 13 | 0 | 1 | 3 | 6 |
| 13 | | | | | | | | | |
| 112-125/ | 118 | 0 | 0 | 8 | 13 | 0 | 1 | 3 | 6 |
| 13 | | | | | | | | | |
| 114-126/ | 119 | 0 | 0 | 8 | 12 | 0 | 1 | 3 | 6 |
| 12 | | | | | | | | | |
| 115-127/ | 120 | 0 | 0 | 7 | 12 | 0 | 1 | 3 | 6 |
| 12 | | | | | | | | | |
| 117-129/ | 121 | 0 | 0 | 7 | 12 | 0 | 1 | 3 | 6 |
| 12 | | | | | | | | | |
| 118-130/ | 122 | 0 | 0 | 7 | 12 | 0 | 1 | 3 | 6 |
| 12 | | | | | | | | | |
| 119-131/ | 123 | 0 | 0 | 7 | 12 | 0 | 0 | 2 | 5 |
| 12 | | | | | | | | | |
| 120-132/ | 124 | 0 | 0 | 6 | 11 | 0 | 0 | 2 | 5 |
| 12 | | | | | | | | | |
| 121-133/ | 125 | 0 | 0 | 6 | 11 | 0 | 0 | 2 | 5 |
| 12 | | | | | | | | | |
| 122-134/ | 126 | 0 | 0 | 6 | 11 | 0 | 0 | 2 | 5 |
| 12 | | | | | | | | | |
| 123-135/ | 127 | 0 | 0 | 6 | 11 | 0 | 0 | 2 | 5 |
| 12 | | | | | | | | | |
| 124-136/ | 128 | 0 | 0 | 5 | 10 | 0 | 0 | 2 | 5 |
| 12 | | | | | | | | | |
| 125-137/ | 129 | 0 | 0 | 5 | 10 | 0 | 0 | 2 | 5 |
| 12 | | | | | | | | | |
| 126-138/ | 130 | 0 | 0 | 5 | 10 | 0 | 0 | 2 | 5 |
| 12 | | | | | | | | | |
| 127-139/ | 131 | 0 | 0 | 5 | 10 | 0 | 0 | 2 | 5 |
| 12 | | | | | | | | | |
| 128-140/ | 132 | 0 | 0 | 4 | 10 | 0 | 0 | 2 | 5 |
| 12 | | | | | | | | | |
| 129-140+ | 133 | 0 | 0 | 4 | 9 | 0 | 0 | 2 | 5 |
| 130-140+ | 134 | 0 | 0 | 4 | 9 | 0 | 0 | 2 | 5 |
| 131-140+ | 135 | 0 | 0 | 4 | 9 | 0 | 0 | 2 | 5 |
| 132-140+ | 136 | 0 | 0 | 4 | 9 | 0 | 0 | 2 | 5 |
| 133-140+ | 137 | 0 | 0 | 4 | 9 | 0 | 0 | 2 | 5 |
| 134-140+ | 138 | 0 | 0 | 4 | 9 | 0 | 0 | 2 | 5 |
| 135-140+ | 139 | 0 | 0 | 4 | 9 | 0 | 0 | 2 | 5 |
| 136-140+ | 140 | 0 | 0 | 4 | 8 | 0 | 0 | 2 | 5 |

3. Course Adjustments

As data is collected for multiple players/multiple games on a given course, an adjustment to the par value for a particular course may be made. Comparisons between courses and individual holes yield a “resistance to par” factor for each hole, and cumulatively a resistance to par factor for the course. Thus the AS calculation for a course is adjusted to render a more effective AS score as scoring data for multiple games/players is accumulated by the system. As more data is collected, a “real-time” adjustment of course playability will be produced, which may include greens condition and weather conditions as player scores cause course adjustments for a given period.

The system course ratings (and putting ratings as described hereinafter) can be determined solely by historical empirical data or by player-supplied data. Golf associations generally have access to large data collections that may yield player-independent course ratings that are preferred to player-supplied data. However, some potential managers of the system of the present invention may either not have access to such data, or may prefer to use player-supplied data as a basis for course evaluation. The description below applies to a transitional system where empirical data is used first, then player-supplied data supplants the empirical data after sufficient player-supplied data is collected. For systems managers having no empirical starting point, numbers as disclosed as described in this application can be used as a starting point prior to collection of empirical or player-supplied data for use with either of the alternative techniques.

Player golf course evaluation is conducted by player-supplied input to the system that includes hole-by-hole rankings, course rankings and putting rankings that will be described below in the section on putting. The player hole ranking is provided on a scale of 1 to 10 with 1 being the easiest hole of that type ever played by a player and 10 being the most difficult. The player course ranking is the sum of the player hole rankings. The course ranking can be divided by par to yield an “effective course-par ranking.” The course ranking information can be used as mentioned above to compute effective par to adjust the course par value as played-supplied data becomes available. Dividing the course ranking by a player's SA provides a course-by-course evaluation of the player's performance against the courses. As data is accumulated, a player can identify courses suited to his or her game. Also, the above computation is useful for course managers and tournament organizers in predicting a player's scores against one or more courses.

4. Putting Grades, Putting Average and Evaluation of Greens

The putting average produced by the SA method and system provides an indication to a golfer of their putting performance relative to other golfers of similar scoring ability. The putting grade provides a current scale for personal evaluation of a particular game. Putting performance is dependent on a number of factors, including number of putts taken, size of greens, the general condition of the greens, the speed of the greens and the capability of the individual player. Green sizes are categorized by square footage and an average putting distance for a player hitting a green in regulation is determined as one half of the distance between the center and the edge of the green. The average green radius is 14y as the average green diameter is 28y. The fewer the number of greens hit in regulation, the less the average distance to the hole is for the first putt, but this factor becomes statistically insignificant when viewed over many rounds of golf for a given player. Statistical analysis has shown that the number of putts taken is not as important as the individual's statistics over time and the relationship of their putting performance to others of similar scoring average. The putting difficulty of individual courses is determined as data is collected by the system and becomes a component of the effective par of the course as used in the scoring average calculations.

The SA system evaluates course conditions faced by a player at a given course and compares them to other courses so that the evaluation is determined for the individual golfer. The course condition factor is a numerical evaluation of the difficulty of the greens on a course, yielding a green rating (GR) on a scale of 1-10 for each green which is totaled for a given course to produce a theoretical range of 18-180. GRs are ordinarily within the range of 60-144. Difficulty factors include contours, grass varieties, ball-roll speed. Green size is a separate part of the putting evaluation formula.

As data is collected by the system (and if the use of player-supplied data is to be integrated as described above), green ratings are updated and refined according to player-supplied data that is compared to other courses having similar characteristics. The player-supplied data is in the form of a Green Ranking input of four factors on a scale of 1 to 5, with 1 corresponding to the easiest greens the player has played and 5 corresponding to the most difficult. The factors are size, undulations, consistency and speed, in accordance with the following table:

TABLE 2

| Rating | Size | Undulations | Consistency | Speed |
|---|---|---|---|---|
| 1 | Small | Flat | Smooth | Slow |
| 2 | — | — | — | — |
| 3 | Average | Average | Average | Average |
| 4 | — | — | — | — |
| 5 | Largest | Multiple | Rough and | Fast |
| | | and Severe | Grainy | |

The Green Ranking is then determined by averaging the factors to provide a single number between 1 and 5.

Before sufficient player-supplied data is available, the green size and green rating information is used to determine a Green Difficulty Adjustment (GDA) according to:

GDA=(Green Rating−90)/10+(Average Green Radius−14)

After player-supplied data has been collected in sufficient quantity, the system will adjust the GDA according to:

GDA=⅕×(Player Green Ranking×18 (#holes)−45 (average rating))

The GDA is combined with the expected putts-per-round for an average player to yield the PB for a given course, calculated (for men) as:

PB=32+GDA

and for women as:

PB=36+GDA

The Putting Basis represents the putting rating of an average player as adjusted for course difficulty via the green difficulty adjustment. An adjusted putt (AP) figure is used to adjust the player's putting round against an average course and a simple average of AP scores yields the putting average (PA) for each player, which can be used by a player to track their progress over time. The AP figure is computed as:

AP=Total Putts−GDA

A putting grade is then produced as a letter grade from A+ to E− determined by subtracting the an average putting factor (32 for men, 36 for women) from the AP, and rounding off to the nearest integer, which produces an adjustment to the anticipated average grade of “C+”. The AP-32 {36 for women] values yield a letter grade as follows: A+ (−6 or lower), A(−5), A− (−4), B+ (−3), B (−2), B− (−1), C+ (0), C (+1), C− (+2), D+ (+3), D(+4), D− (+5), E+ (+6), E(+7) and E− (+8 or higher). For example, a male golfer who putts a 35 with a green difficulty adjustment of −1.8, achieves an AP of 36.8. The putting grade is then 36.8−32 =4.8 which rounds to 5 for a putting grade of “D−”.

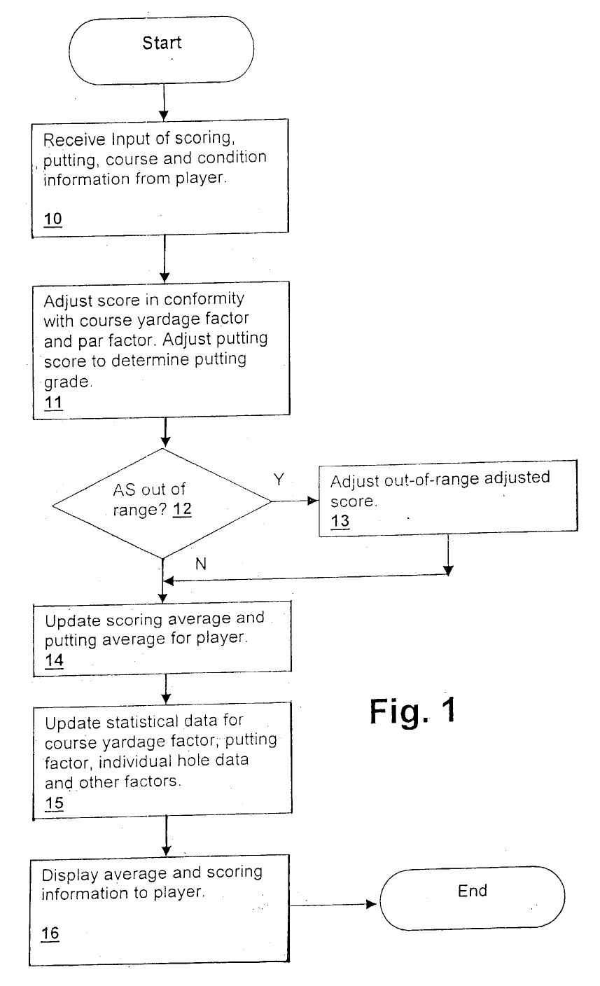

Referring now to the figures and in particular to FIG. 1, a method for determining golf scoring averages in accordance with an embodiment of the present invention is shown in a flowchart. A golfer, upon completing a game, enters their scoring information via a keyboard, mouse, touchscreen or other input device (step 10). The scoring information may also include course condition and weather information for use by the calculations of the method. The scoring information is used to determine an adjusted score (AS) in conformity with a course yardage factor and a par factor determined for the course (step 11). The putting score may also be adjusted to determine a putting grade.

Next, if the AS is determined to be out of range based on the statistically predicted scoring ranges (decision 12), the AS is adjusted (step 13). The AS is then used to update a scoring average and the putting information is used to update a putting average for the player (step 14). Next, statistical data for the course par factor and/or the course yardage factor are updated to incorporate the scoring information in the statistical base (step 15). Finally, the average and scoring information is displayed to the golfer (step 16).

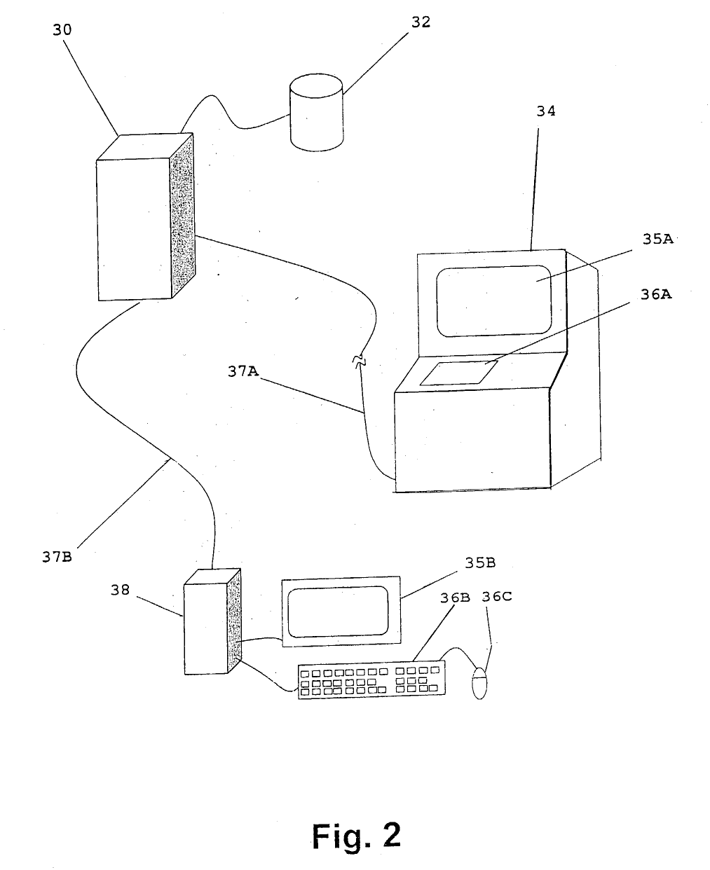

Referring now to FIG. 2 a system in accordance with an embodiment of the invention is depicted. The system depicted is intended to be exemplary and does not limit the structure of other systems in accordance with embodiments of the present invention. The system includes a server 30, which may be an Internet server or other dedicated network server. Coupled to server is shown a storage system 32 for storing collected scoring information and other data for computing player and course statistics. Server 30 is shown coupled via a network connection 37A (which may be a telephone connection or broadband network connection) to a dedicated station 34 as may be deployed in golf shops and golf course locations, so that golfers may input scoring information and access their scoring history and current performance. Dedicated station 34 includes an input device 36A such as a keypad or electronic writing pad for receiving the scoring and course information from a golfer. Input device 36A may also be integrated with a display 35A that displays the scoring history and computed results of the method of the present invention as executed by a computer program either within dedicated station 34 or server 30.

Server 30 is also shown coupled to a general-purpose computer 38 via a network connection 37B, which may be an Internet connection to a home computer (38). General-purpose computer 38 is coupled to a display 35B, a mouse 36C and a keyboard 36B providing input and output for programs executing within general-purpose computer 38, such as a network browser accessing web pages served server 30. A system solely of dedicated stations 34 may be constructed, a system solely of general-purpose computers 38 or a combination of both may be configured in accordance with various embodiments of the present invention.

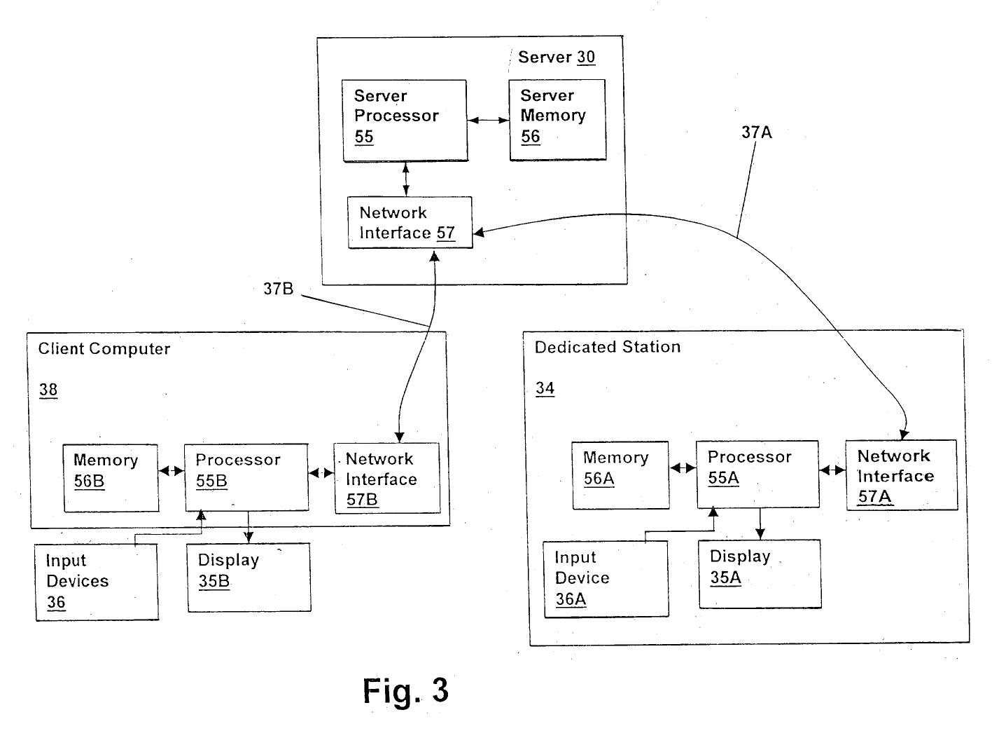

Referring now to FIG. 3, a block diagram of the system of the present invention is depicted. Server 30 includes a server processor 55, server memory 56 and a network interface 57 that is coupled to client computer 38 and dedicated station 34. Server memory 56 contains program instructions for executing steps of the method of the present invention. Client computer 38 comprises a memory 56B a processor 55B and a network interface 57B for communicating with server 30. Server 30 may provide only the statistical data required for computation of the methods of the present invention by processor 55B, or processor 55B may execute a web browser from memory 56B, sending scoring information input to server 30 and receiving a display of output from server 30 as a pushed web page or input to a JAVA or other applet program executing within client computer 38. Display 35B and input devices 36 are coupled to client computer 38 for display of results and input of scoring information.

Dedicated station 34 is coupled to server 30 network interface 57 via network connection 37A. Dedicated station 34 includes a processor 55A coupled to network interface 57A, memory 56A, input device 36A and display 35A, providing a completely integrated terminal for input of golf scoring information and display of historical and current performance data. Memory 56A may contain computer program products implementing methods in accordance with embodiments of the present invention, or may contain a web browser or other dedicated program for collection of input scoring information and display of results from server 30.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for producing a score indicating result of an individual player on a selected golf course, comprising:
receiving input of scoring information from a game played by said individual player;
computing an adjusted score by adding a factor corresponding to a reduction of yardage from an average course yardage for said selected golf course and adding a second factor corresponding to a reduction of par from an average course for said selected golf course; and
displaying said adjusted score.

2. The method of claim 1, further comprising:
accumulating a plurality of adjusted scores for a plurality of games played by said individual player;
averaging said plurality of adjusted scores to determine a scoring average for said individual player; and
displaying said scoring average.

3. The method of claim 1, further comprising:
collecting statistical data for said selected golf course in conformity with said received scoring information input and further scoring information received from other players; and
computing at least one of said first factor and said second factor from said statistical data.

4. The method of claim 1, further comprising:
selecting one of a plurality of statistically determined scoring ranges for said individual player in conformity with said received scoring information; and
adjusting said adjusted score in conformity with said selected one of said scoring ranges.

5. The method of claim 1, wherein said received scoring information includes putting information and wherein said method further comprises:
computing an adjusted number of putts by adding a third factor corresponding to a green rating for said selected golf course and adding a fourth factor corresponding to a reduction of green radius from an average course green radius for said selected golf course; and
displaying said adjusted number of putts.

6. The method of claim 5, further comprising:
computing a putting grade by adjusting said adjusted number of putts by a fifth factor corresponding to an average player putting performance; and
displaying said putting grade.

7. The method of claim 1, further comprising:
accumulating a plurality of adjusted number of putts scores for a plurality of games played by said individual player;
averaging said plurality of adjusted number of putts to determine a putting average for said individual player; and
displaying said putting average.

8. The method of claim 1, wherein said received scoring information further comprises course condition information, and wherein at least one of said first and second factors are adjusted in conformity with said course condition information.

9. The method of claim 1, wherein said received scoring information further comprises weather information, and wherein at least one of said first and second factors are adjusted in conformity with said weather information.

10. A computer system, comprising a processor coupled to a memory containing program instructions for execution by said processor and data for use by said program instructions, wherein said program instructions comprise program instructions for:
receiving input of scoring information from a game played by said individual player;
computing an adjusted score by adding a factor corresponding to a reduction of yardage from an average course yardage for said selected golf course and adding a second factor corresponding to a reduction of par from an average course for said selected golf course; and
displaying said adjusted score.

11. The computer system of claim 10, wherein said program instructions further comprise program instructions for:
accumulating a plurality of adjusted scores for a plurality of games played by said individual player;
averaging said plurality of adjusted scores to determine a scoring average for said individual player; and
displaying said scoring average.

12. The computer system of claim 10, wherein said program instructions further comprise program instructions for:
collecting statistical data for said selected golf course in conformity with said received scoring information input and further scoring information received from other players; and
computing at least one of said first factor and said second factor from said statistical data.

13. The computer system of claim 10, wherein said program instructions further comprise program instructions for:
selecting one of a plurality of statistically determined scoring ranges for said individual player in conformity with said received scoring information; and
adjusting said adjusted score in conformity with said selected one of said scoring ranges.

14. The computer system of claim 10, wherein said received scoring information includes putting information and wherein said program instructions further comprise program instructions for:
computing an adjusted number of putts by adding a third factor corresponding to a green rating for said selected golf course and adding a fourth factor corresponding to a reduction of green radius from an average course green radius for said selected golf course; and
displaying said adjusted number of putts.

15. The computer system of claim 14, wherein said program instructions further comprise program instructions for:
computing a putting grade by adjusting said adjusted number of putts by a fifth factor corresponding to an average player putting performance; and
displaying said putting grade.

16. The computer system of claim 14, wherein said program instructions further comprise program instructions for:
accumulating a plurality of adjusted number of putts scores for a plurality of games played by said individual player;
averaging said plurality of adjusted number of putts to determine a putting average for said individual player; and
displaying said putting average.

17. The computer system of claim 10, wherein said computer system is a dedicated terminal located in a commercial location for receiving entry of said scoring information from multiple players.

18. The computer system of claim 17, wherein said computer system comprises a network interface for connection to a server system for collection of data and distribution of at least one of said first and said second factors to said computer system and collection of said scoring information by said server.

19. The computer system of claim 10, wherein said computer system comprises an Internet server coupled to a general purpose computer executing an Internet browser program, and wherein said program instructions for receiving, computing and displaying are executed by said Internet server for collecting said scoring information from said general purpose computer and displaying said adjusted score on said general purpose computer.

20. A computer program product, comprising signal bearing media encoding program instructions and data for execution by a processor within a computer system, wherein said program instructions comprise program instructions for:
receiving input of scoring information from a game played by said individual player;
computing an adjusted score by adding a factor corresponding to a reduction of yardage from an average course yardage for said selected golf course and adding a second factor corresponding to a reduction of par from an average course for said selected golf course; and
displaying said adjusted score.

21. The computer program product claim 20, wherein said program instructions further comprise program instructions for:
accumulating a plurality of adjusted scores for a plurality of games played by said individual player;
averaging said plurality of adjusted scores to determine a scoring average for said individual player; and
displaying said scoring average.

22. The computer program product of claim 20, wherein said program instructions further comprise program instructions for:
collecting statistical data for said selected golf course in conformity with said received scoring information input and further scoring information received from other players; and
computing at least one of said first factor and said second factor from said statistical data.

23. The computer program product of claim 20, wherein said program instructions further comprise program instructions for:
selecting one of a plurality of statistically determined scoring ranges for said individual player in conformity with said received scoring information; and
adjusting said adjusted score in conformity with said selected one of said scoring ranges.

24. The computer program product of claim 20, wherein said received scoring information includes putting information and wherein said program instructions further comprise program instructions for:
computing an adjusted number of putts by adding a third factor corresponding to a green rating for said selected golf course and adding a fourth factor corresponding to a reduction of green radius from an average course green radius for said selected golf course; and
displaying said adjusted number of putts.

25. The computer program product of claim 20, wherein said program instructions further comprise program instructions for:
computing a putting grade by adjusting said adjusted number of putts by a fifth factor corresponding to an average player putting performance; and
displaying said putting grade.

26. The computer program product of claim 20, wherein said program instructions further comprise program instructions for:
accumulating a plurality of adjusted number of putts scores for a plurality of games played by said individual player;
averaging said plurality of adjusted number of putts to determine a putting average for said individual player; and
displaying said putting average.

27. The computer program product of claim 20, wherein said computer program product is a program for operating a dedicated terminal located in a commercial location for receiving entry of said scoring information from multiple players.

28. The computer program product of claim 20, wherein said computer program product is a server program for execution by an Internet server coupled to a general purpose computer executing an Internet browser program, and wherein said program instructions for receiving, computing and displaying are executed by said Internet server for collecting said scoring information from said general purpose computer and displaying said adjusted score on said general purpose computer.
